(19) United States
(12) Patent Application Publication
(10) Pub. No.: US 2004/0043189 A1
(43) Pub. Date: Mar. 4, 2004

(54) Perforated plastically deformable sheet and method for making the same

(76) Inventor: Chen-Cheng Huang, Taipei City (TW)

Correspondence Address: STEPHEN P. EVANS, MARSHALL & MELHORN, LLC, FOUR SEAGATE, 8TH FLOOR, TOLEDO, OH, 43604, US

(21) Appl. No.: 10/404,367

(22) Filed: Apr. 1, 2003

(30) Foreign Application Priority Data
Sep. 4, 2002 (TW) 091213899

(51) Int. Cl. B32B 3/10

(52) U.S. Cl. 428/131

(57) ABSTRACT

A perforated plastically deformable sheet includes a plastically deformable sheet with top and bottom surfaces. The plastically deformable sheet is formed with a plurality of recesses and a plurality of capillaries, each of which extends from a respective one of the recesses. Each of the recesses has a cross-section greater than that of the respective one of the capillaries.

### BACKGROUND OF THE INVENTION

1. Field of the Invention

This invention relates to a perforated plastically deformable sheet and a method for making the same, more particularly to a perforated plastically deformable sheet with a plurality of recesses and a plurality of capillary units and to a method for forming the recesses and the capillary units in the perforated plastically deformable sheet.

2. Description of the Related Art

FIGS. 1 and 2 illustrate a conventional perforated plastically deformable sheet 2 that can be used as a top sheet of an absorptive device, such as diapers, bandages, water-retaining agent for agriculture use, and sanitary napkins or can be used as packaging and decorating material. The perforated plastically deformable sheet 2 has opposite top and bottom surfaces 21, 22, and is perforated to form a plurality of tapered capillaries 23. Each of the capillaries 23 has a bottom opening 231 spaced apart from the bottom surface 22 in a direction away from the top surface 21 and adapted to be in intimate contact with an absorbent batt (not shown) so that liquid accumulated on the top surface 21 of the plastically deformable sheet 2 can be absorbed by the absorbent batt through the capillaries 23 (a wicking action). Formation of the capillaries 23 is performed by advancing a softened plastically deformable sheet through a vacuum screen drum, which causes the softened plastically deformable sheet to rupture at screen holes in the vacuum screen drum.

The conventional perforated plastically deformable sheet 2 is disadvantageous in that the height of each of the thus formed capillaries 23 is relatively small and a sufficient distance between the absorbent batt and the top surface 21 cannot be provided to prevent liquid from wetbacking from the absorbent batt to the top surface 21 (which is in contact with the user's skin). Moreover, since prolonged contact with the perforated plastically deformable sheet 2 can irritate the user's skin, there is a need to minimize the contact area of the perforated plastically deformable sheet 2 with the user's skin.

### SUMMARY OF THE INVENTION

Therefore, the object of the present invention is to provide a perforated plastically deformable sheet that is capable of overcoming the aforesaid drawbacks of the prior art.

Another object of the present invention is to provide a method for making the perforated plastically deformable sheet.

According to one aspect of the present invention, a perforated plastically deformable sheet comprises: a plastically deformable sheet having opposite top and bottom surfaces and formed with a plurality of spaced apart recesses and a plurality of spaced apart capillary units that are vertically and respectively aligned with the recesses. Each of the capillary units includes at least one capillary that has a cross-section less than that of the respective one of the recesses. Each of the recesses is indented from the top surface toward the bottom surface and is confined by a recess-confining wall that has a peripheral surface extending downwardly from the top surface toward the bottom surface, and a bight surface that extends laterally from the peripheral surface. The capillary of each of the capillary units extends downwardly from the bight surface of the recess-confining wall of the respective one of the recesses in a transverse direction relative to the bight surface, and has a top opening adjoining the respective one of the recesses and a bottom opening opposite to the top opening and spaced apart from the bottom surface in a direction away from the top surface.

According to another aspect of the present invention, a method for making the perforated plastically deformable sheet comprises t-he steps of: (a) preparing a plastically deformable sheet; (b) preparing a screen mold including a first screen element and a second screen element connected to and disposed above the first screen element, the first and second screen elements being respectively formed with a plurality of first and second screen holes, each of the second screen holes having a cross-section greater than those of the first screen holes, each of the second screen holes spanning at least one of the first screen holes; (c) heating and softening the plastically deformable sheet and laying the plastically deformable sheet on the second screen element; and (d) applying a negative pressure at one side of the first screen element opposite to the softened plastically deformable sheet in such a manner that the softened plastically deformable sheet is pulled and ruptured at the first screen holes.

### BRIEF DESCRIPTION OF THE DRAWINGS

In drawings which illustrate embodiments of the invention,

FIG. 1 is a fragmentary perspective view of a conventional perforated plastically deformable sheet for an absorptive device;

FIG. 2 is a fragmentary sectional view of the perforated plastically deformable sheet of FIG. 1;

FIG. 3 is a fragmentary top view of a preferred embodiment of a perforated plastically deformable sheet according to this invention;

FIG. 4 is a sectional view taken along line IV-IV in FIG. 3;

FIG. 5 is a schematic side view illustrating how the perforated plastically deformable sheet of FIG. 3 is made using a vacuum screen drum of an apparatus according to a method of this invention;

FIG. 6 is a fragmentary perspective view of a screen mold of the vacuum screen drum shown in FIG. 5;

FIG. 7 is a schematic side view of another apparatus for making the perforated plastically deformable sheet according to this invention; and

FIG. 8 is a fragmentary sectional view of a second preferred embodiment of the perforated plastically deformable sheet according to this invention.

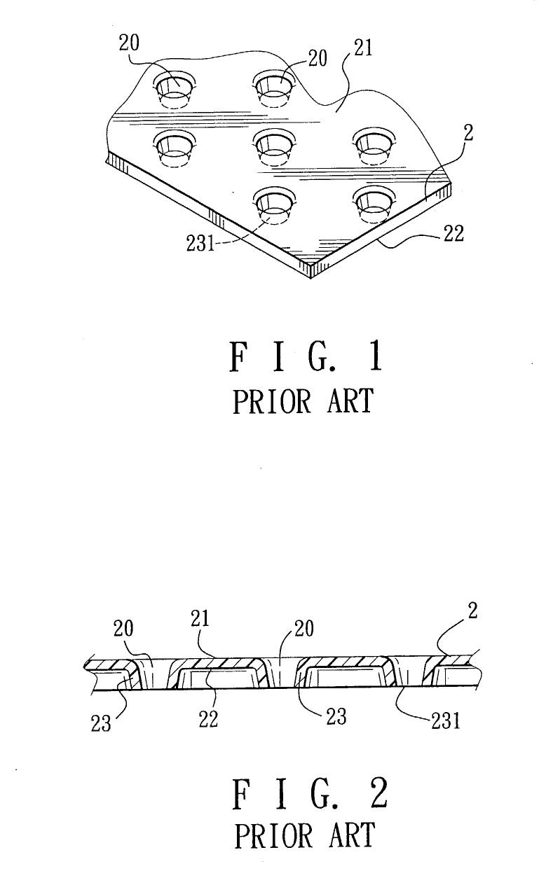

### DETAILED DESCRIPTION OF THE PREFERRED EMBODIMENTS

For the sake of brevity, like elements are denoted by the same reference numerals throughout the disclosure.

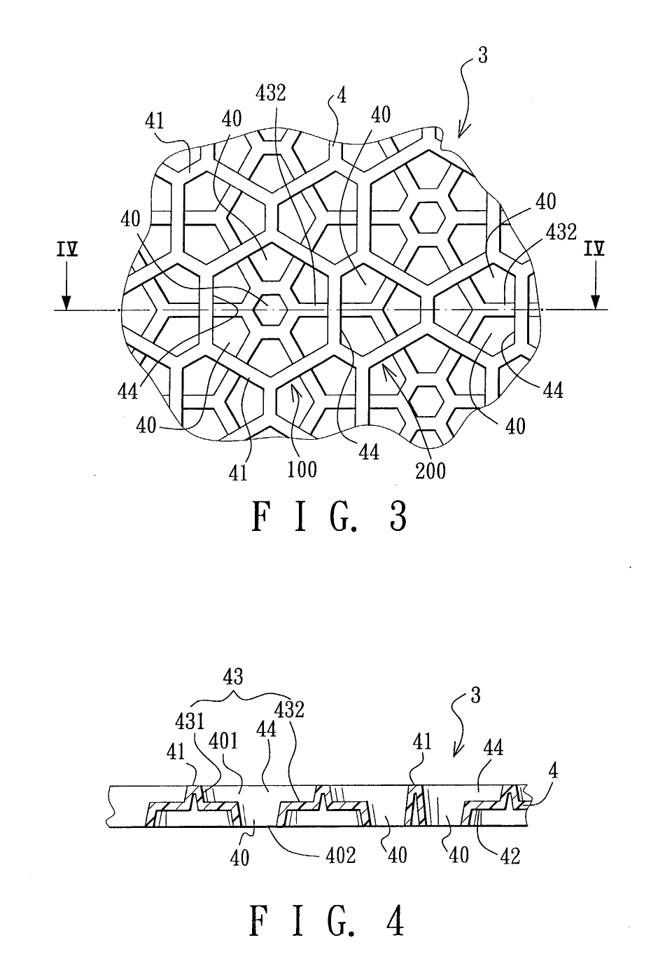

FIGS. 3 and 4 illustrate a first preferred embodiment of a perforated plastically deformable sheet 3 of this invention that can be used as a top sheet of an absorptive device, such as diapers, bandages, water-retaining agent for agriculture use, and sanitary napkins or can be used as packaging and decorating material.

The perforated plastically deformable sheet 3 includes: a plastically deformable sheet 4 having opposite top and bottom surfaces 41, 42 and formed with a plurality of spaced apart recesses 44 and a plurality of spaced apart capillary units that are vertically and respectively aligned with the recesses 44. Each of the capillary units includes at least one capillary 40 that has a cross-section less than that of the respective one of the recesses 44. Each of the recesses 44 is indented from the top surface 41 toward the bottom surface 42, and is confined by a recess-confining wall 43 that has a peripheral surface 431 extending downwardly from the top surface 41 toward the bottom surface 42, and a bight surface 432 that extends laterally from the peripheral surface 431. The capillary 40 of each of the capillary units extends downwardly from the bight surface 432 of the recess-confining wall 43 of the respective one of the recesses 44 in a transverse direction relative to the bight surface 432, and has a top opening 401 adjoining the respective one of the recesses 44 and a bottom opening 402 opposite to the top opening 401 and spaced apart from the bottom surface 42 in a direction away from the top surface 41.

In this preferred embodiment, the recesses 44 are hexagonal in shape, are classified into two different sizes, and have a pattern such that each of the larger ones (indicated as reference numeral 100 in FIG. 3) of the recesses 44 is surrounded by a plurality of the smaller ones (indicated as reference numeral 200 in FIG. 3) of the recesses 44. Each of the larger ones 100 of the recesses 44 spans seven capillaries 40 of a respective one of the capillary units. Each of the smaller ones of the recesses 44 spans three capillaries 40 of a respective one of the capillary units.

The perforated plastically deformable sheet 3 is preferably made from a hydrophobic and non-woven fabric. The non-woven fabric is preferably a fibrous based material which can contain solely a fiber material or a mixture of different fiber materials. Each of the capillaries 40 of the capillary units is tapered from the top opening 401 toward the bottom opening 402.

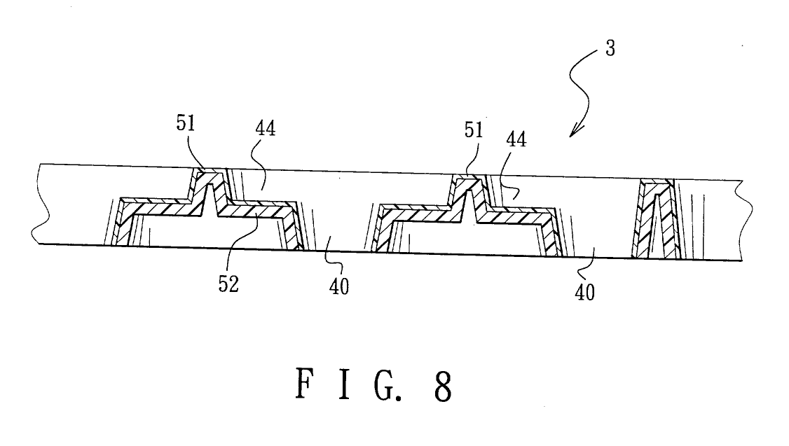

FIG. 8 illustrates a second preferred embodiment of the perforated plastically deformable sheet of this invention that has a structure similar to the previous embodiment shown in FIG. 4, except that the perforated plastically deformable sheet 3 of this embodiment includes a top layer 51 of a hydrophilic material and a bottom layer 52 of a hydrophobic material that is adhered to a bottom side of the top layer 51.

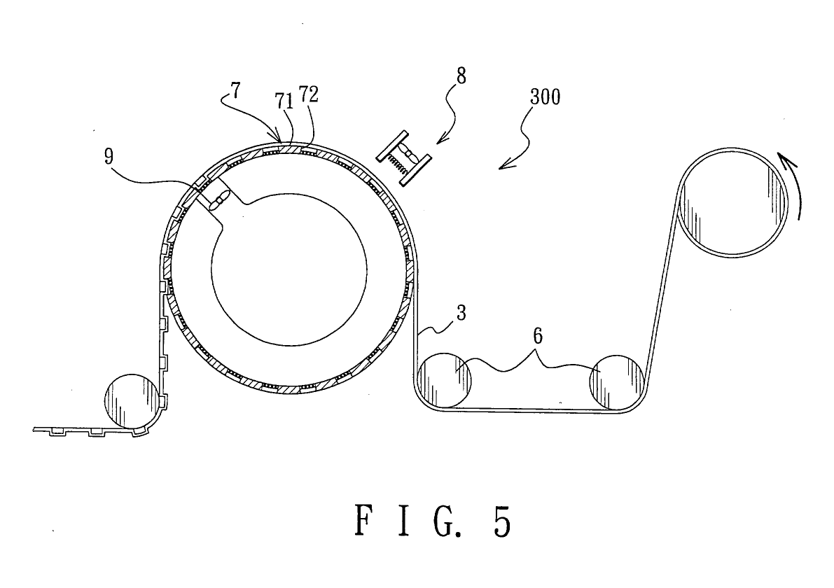

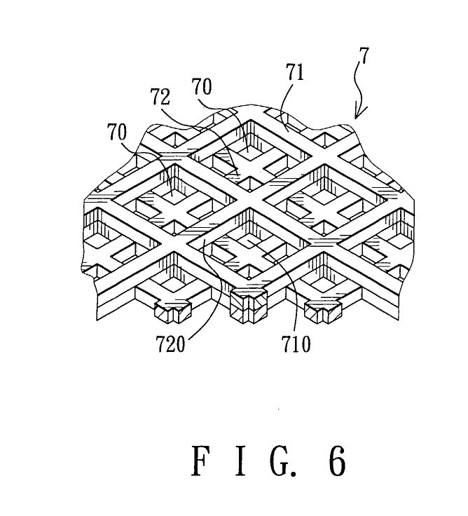

FIGS. 5 and 6 illustrate an apparatus 300 for making the perforated plastically deformable sheet 3 according to a method of this invention. The method includes the steps of: (a) preparing a plastically deformable sheet 4; (b) preparing a drum-type screen mold 7 including a first screen element 71 and a second screen element 72 connected to and disposed above the first screen element 71, the first and second screen elements 71, 72 being respectively formed with a plurality of first and second screen holes 710, 720, each of the second screen holes 720 having a cross-section greater than those of the first screen holes 710, each of the second screen holes 720 spanning at least one of the first screen holes 710; (c) heating and softening the plastically deformable sheet 4 using a heater 8, laying the plastically deformable sheet 4 on the second screen element 72, and passing the plastically deformable sheet 4 over the screen mold 7 using a set of rollers 6; and (d) applying a negative pressure at one side of the first screen element 71 opposite to the softened plastically deformable sheet 4 using a vacuum device 9 in such a manner that the softened plastically deformable sheet 4 is pulled and ruptured at the first screen holes 710 so as to form the recesses 44 that respectively correspond to the second screen holes 720 and so as to form the capillaries 40 that respectively correspond to the first screen holes 710.

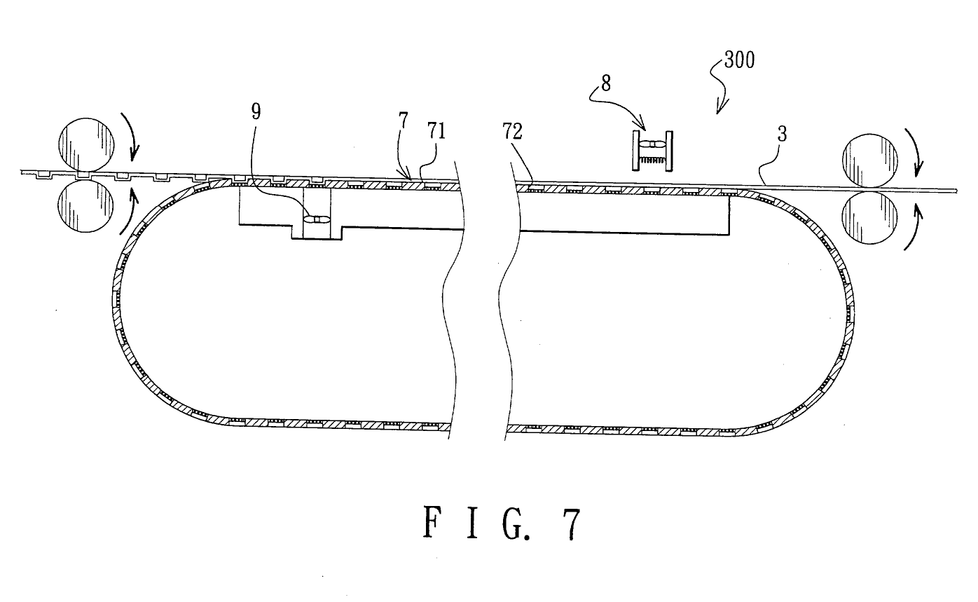

FIG. 7 illustrates another apparatus 300 that is similar to the apparatus 300 shown in FIG. 5, except that the screen mold 7 is elliptical in shape.

With the inclusion of the recesses 44 in the perforated plastically deformable sheet 3, the drawbacks as encountered in the prior art can be eliminated. Moreover, the recesses 44 permit the liquid that accumulated on the top surface 41 of the perforated plastically deformable sheet 3 to be quickly drained thereinto, thereby allowing a greater degree of dryness on the top surface 41 of the perforated plastically deformable sheet 3.

With the invention thus explained, it is apparent that various modifications and variations can be made without departing from the spirit of the present invention. It is therefore intended that the invention be limited only as recited in the appended claims.

I claim:

1. A perforated plastically deformable sheet comprising:
a plastically deformable sheet having opposite top and bottom surfaces and formed with a plurality of spaced apart recesses and a plurality of spaced apart capillary units that are vertically and respectively aligned with said recesses, each of said capillary units including at least one capillary that has a cross-section less than that of the respective one of said recesses, each of said recesses being indented from said top surface toward said bottom surface and being confined by a recess-confining wall that has a peripheral surface extending downwardly from said top surface toward said bottom surface, and a bight surface that extends laterally from said peripheral surface, said capillary of each of said capillary units extending downwardly from said bight surface of said recess-confining wall of the respective one of said recesses in a transverse direction relative to said bight surface and having a top opening adjoining the respective one of said recesses and a bottom opening opposite to said top opening and spaced apart from said bottom surface in a direction away from said top surface.

2. The perforated plastically deformable sheet of claim 1, wherein said capillary of each of said capillary units is tapered from said top opening toward said bottom opening.

3. The perforated plastically deformable sheet of claim 1, wherein said plastically deformable sheet is made from a plastic material that is hydrophobic.

4. The perforated plastically deformable sheet of claim 1, wherein said plastically deformable sheet includes a top layer of a hydrophilic material and a bottom layer of a hydrophobic material.

5. The perforated plastically deformable sheet of claim 1, wherein said plastically deformable sheet is made from a non-woven fabric.

6. A method for making a perforated plastically deformable sheet, said method comprising the steps of:
(a) preparing a plastically deformable sheet;
(b) preparing a screen mold including a first screen element and a second screen element connected to and disposed above said first screen element, said first and second screen elements being respectively formed with a plurality of first and second screen holes, each of said second screen holes having a cross-section greater than those of said first screen holes, each of said second screen holes spanning at least one of said first screen holes;
(c) heating and softening said plastically deformable sheet and laying said plastically deformable sheet on said second screen element; and
(d) applying a negative pressure at one side of said first screen element opposite to said softened plastically deformable sheet in such a manner that said softened plastically deformable sheet is pulled and ruptured at said first screen holes.

7. The method of claim 6, wherein said screen mold is formed by stacking said second screen element over said first screen element.
